(19) United States
(12) Patent Application Publication
(10) Pub. No.: US 2024/0183438 A1
(43) Pub. Date: Jun. 6, 2024

(54) GEAR DEVICE, BEARING REMOVAL DEVICE, AND BEARING REMOVAL METHOD

(71) Applicant: Mitsubishi Electric Corporation, Chiyoda-ku, Tokyo (JP)

(72) Inventor: Yoshiki AZUMA, Chiyoda-ku, Tokyo (JP)

(73) Assignee: Mitsubishi Electric Corporation, Chiyoda-ku, Tokyo (JP)

(21) Appl. No.: 18/551,689

(22) PCT Filed: Jun. 4, 2021
(86) PCT No.: PCT/JP2021/021438

§ 371 Date: Sep. 21, 2023

(51) Int. Cl. F16H 57/021; F16H 57/00; F16H 57/02

(52) U.S. Cl. CPC F16H 57/021; F16H 57/0025; F16H 2057/0062; F16H 2057/02043

(57) ABSTRACT

A gear device includes a gear attached to a shaft to rotate integrally with the shaft, a pair of bearings located across the gear in a direction in which the shaft extends and supporting the shaft in a rotatable manner, and a plurality of removable members attached to the gear. The plurality of removable members are attached to two surfaces of the gear intersecting with the shaft. Each removable member of the plurality of removable members faces a bearing of the pair of bearings located across the gear.

### TECHNICAL FIELD

The present disclosure relates to a gear device, a bearing remover, and a bearing removal method.

### BACKGROUND ART

A railway vehicle includes a gear device that transmits rotational force from a motor to an axle. An example of such a gear device is described in Patent Literature 1. The gear device described in Patent Literature 1 includes a pinion coupled to the output shaft of the motor and a gear wheel engaged with the pinion and coupled to the axle. The gear device further includes output shaft bearings that support the output shaft in a rotatable manner, axle bearings that support the axle in a rotatable manner, and a gear box that accommodates the pinion, the gear wheel, the output shaft bearings, and the axle bearings.

### CITATION LIST

### Patent Literature

Patent Literature 1: Unexamined Japanese Patent Application Publication No. 2019-219051

### SUMMARY OF INVENTION

### Technical Problem

The output shaft bearings receive the load resulting from the weight of a rotator supported by the output shaft bearings in a rotatable manner, or more specifically, the weight of the output shaft to which the pinion is attached. The output shaft bearings thus have a shorter life than the pinion. Similarly, the axle bearings receive a load resulting from the weight of a rotator supported by the axle bearings in a rotatable manner, or more specifically, the weight of the axle to which the gear wheel is attached. The axle bearings thus have a shorter life than the gear wheel. Thus, among the components in the gear device, the output shaft bearings and the axle bearings may be replaced. For example, in the gear device described in Patent Literature 1, output shaft bearings can be removed easily by removing a lid, to which the output shaft bearings are fitted, together with the output shaft bearings from the gear device, but removal of the axle bearings is complicated.

More specifically, to remove the axle bearings that support the axle, a bearing box holding the axle bearings is removed from the gear box. To remove the axle bearings, the axle is then to be removed first from the gear device. When the gear wheel is tightly fitted to the axle, removal of the axle from the gear device is complicated, and thus removal of the axle bearings from the gear device is complicated. In addition to a gear device installed in a railway vehicle, such inconvenience may occur in various gear devices including bearings that support a shaft to which a gear is attached in a rotatable manner.

An objective of the present disclosure is to provide a gear device, a bearing remover, and a bearing removal method allowing easy removal of a bearing.

### Solution to Problem

To achieve the above objective, a gear device according to an aspect of the present disclosure includes a gear, a pair of bearings, and a plurality of removable members. The gear is attached to a shaft to rotate integrally with the shaft. The pair of bearings are located across the gear in a direction in which the shaft extends. The pair of bearings support the shaft in a rotatable manner. The plurality of removable members are attached to two surfaces of the gear intersecting with the shaft. Each removable member of the plurality of removable members faces a bearing of the pair of bearings located across the gear.

### Advantageous Effects of Invention

The gear device according to the above aspect of the present disclosure includes the plurality of removable members attached to the gear. Each removable member of the removable members faces either bearing of the pair of bearings located across the gear. Thus, moving the removable members in contact with the bearings along the shaft allows easy removal of the bearings from the shaft.

### BRIEF DESCRIPTION OF DRAWINGS

FIG. 1 is a top view of a truck to which gear devices according to an embodiment are attached;

FIG. 2 is a cross-sectional view of the gear device according to the embodiment taken along line II-II as viewed in the direction indicated by the arrows in FIG. 1;

FIG. 3 is a cross-sectional view of the gear device according to the embodiment taken along line III-III as viewed in the direction indicated by the arrows in FIG. 2;

FIG. 4 is a partial cross-sectional view of the gear device according to the embodiment;

FIG. 5 is a cross-sectional view of the gear device according to the embodiment;

FIG. 6 is a diagram describing a method for removing bearings in the gear device according to the embodiment;

FIG. 7 is a diagram describing a method for removing bearings in the gear device according to the embodiment;

FIG. 8 is a cross-sectional view of a gear device according to a modification of the embodiment; and

FIG. 9 is a diagram describing a method for removing bearings in the gear device according to the modification of the embodiment.

### DESCRIPTION OF EMBODIMENTS

A gear device, a bearing remover, and a bearing removal method according to an embodiment of the present disclosure are described in detail below with reference to the drawings. In the figures, the same reference signs denote the same or equivalent components.

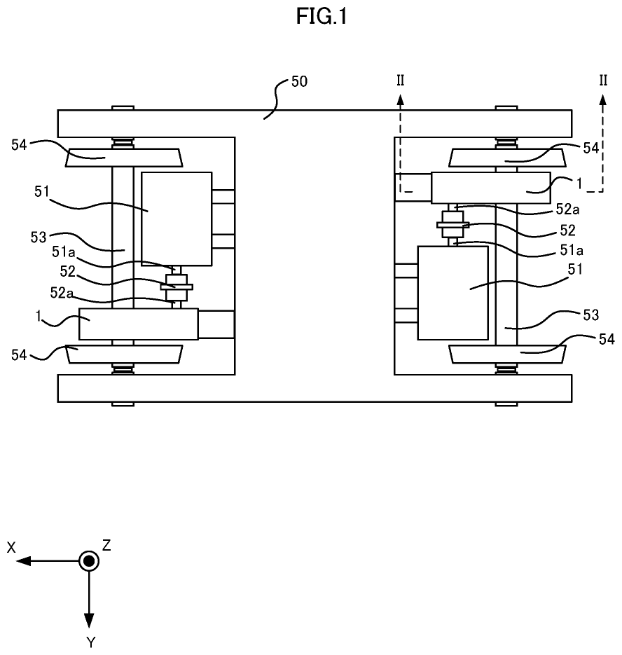

Gear devices 1 according to the embodiment are described using gear devices installed on a railway vehicle as examples. As illustrated in FIG. 1, the gear devices 1 are attached to a truck 50 in a railway vehicle. Motors 51 that transmit rotational force to the gear devices 1 through couplings 52 are attached to the truck 50. Axles 53 are attached to the truck 50 with axle springs, which are not illustrated, in between. Wheels 54 are attached to two ends of each axle 53.

In FIG. 1, Z-axis indicates the vertical direction, X-axis indicates the travel direction of the railway vehicle, and Y-axis indicates the width direction of the railway vehicle, or the direction in which each axle 53 extends. X-axis, Y-axis, and Z-axis are perpendicular to one another. The same applies to the other drawings.

Each motor 51 is a power source driven by power fed from a power source, which is not illustrated, to generate rotational force. When each motor 51 is driven, a shaft 51a rotates.

Each coupling 52 transmits rotational force transmitted from the corresponding shaft 51a to the gear device 1 through a drive shaft 52a. In other words, each drive shaft 52a is driven to rotate by the corresponding motor 51 serving as a power source.

Each axle 53 rotates integrally with the corresponding wheels 54 when receiving rotational force from the corresponding gear device 1.

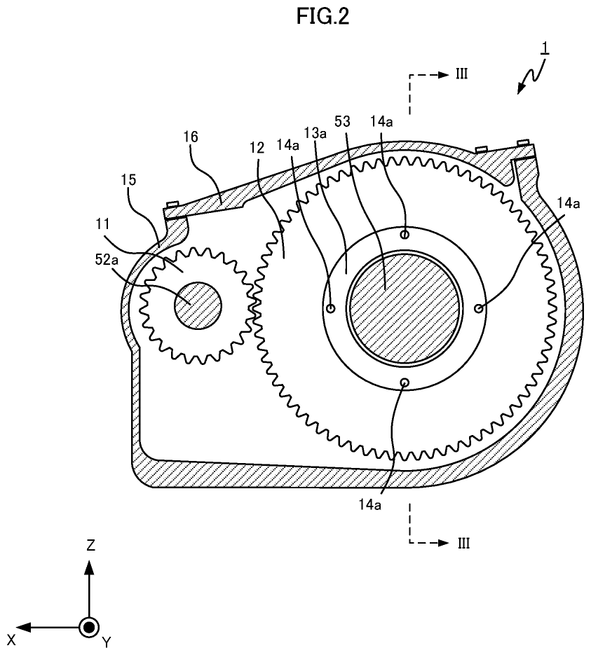

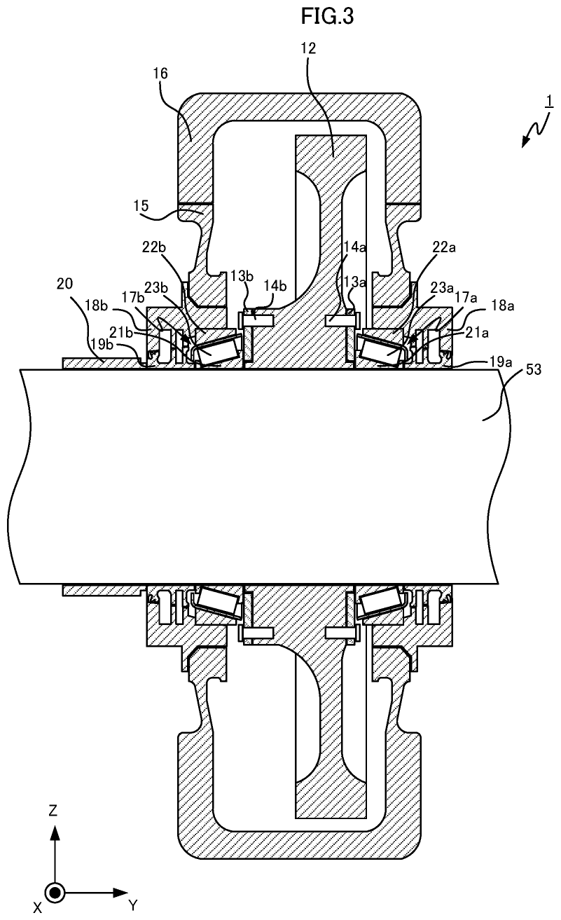

Each gear device 1 includes at least one gear and a pair of bearings that support, in a rotatable manner, a shaft to which the gear is attached. As illustrated in FIG. 2 that is a cross-sectional view taken along line II-II as viewed in the direction indicated by the arrows in FIG. 1, and FIG. 3 that is a cross-sectional view taken along line III-III as viewed in the direction indicated by the arrows in FIG. 2, each gear device 1 includes two gears 11 and 12, a pair of bearings that support, in a rotatable manner, a shaft to which the gear 11 is attached, and a pair of bearings that support, in a rotatable manner, a shaft to which the gear 12 is attached. In the example described below, the gear 11 attached to the drive shaft 52a is referred to as a drive gear 11, and the gear 12 meshing with the drive gear 11 and attached to the axle 53 serving as a follower shaft is referred to as a follower gear 12 for distinguishment. A pair of bearings that support the axle 53 in a rotatable manner are referred to as follower-shaft bearings 17a and 17b, and a pair of bearings that support the drive shaft 52a are referred to as drive-shaft bearings. The drive-shaft bearings are not illustrated.

The gear device 1 further includes a pair of rings 13a and 13b as multiple removable members. The rings 13a and 13b are attached to the follower gear 12 with fasteners 14a and 14b. The removable members are used to remove the follower-shaft bearings 17a and 17b from the corresponding axle 53. The removable members are firmly attached to the follower gear 12 not to be separate from the follower gear 12 during the rotation of the follower gear 12, and are removable from the follower gear 12 with, for example, a tool without being broken.

Each gear device 1 further includes the pair of follower-shaft bearings 17a and 17b that support the axle 53 in a rotatable manner and bearing holders 18a and 18b that respectively hold the follower-shaft bearings 17a and 17b. The follower-shaft bearing 17a is a rolling bearing including an inner race 21a, an outer race 22a, and rolling elements 23a. The follower-shaft bearing 17b is a rolling bearing including an inner race 21b, an outer race 22b, and rolling elements 23b. The gear device 1 further includes a gear box 15 and a lid 16. The gear box 15 accommodates the drive gear 11, the follower gear 12, the pair of follower-shaft bearings 17a and 17b, and the pair of rings 13a and 13b. The lid 16 closes an opening in the gear box 15 at the top in the vertical direction. The gear device 1 further includes oil throwers 19a and 19b and an earth ring 20. The oil throwers 19a and 19b suppress leakage of oil from the gear box 15. The earth ring 20 passes a current from the body of the railway vehicle to the rails through a ground brush, which is not illustrated.

In the gear device 1 with the above structure, when the ring 13a is removed from the follower gear 12 and then the ring 13a in contact with the follower-shaft bearing 17a is moved along the axle 53, the follower-shaft bearing 17a can be removed easily. Similarly, when the ring 13b in contact with the follower-shaft bearing 17b is moved along the axle 53, the follower-shaft bearing 17b can be removed easily. The components of the gear device 1 are described in detail below.

As illustrated in FIGS. 1 and 2, the drive gear 11 is attached to the drive shaft 52a and rotates integrally with the drive shaft 52a. More specifically, as the shaft 51a of the motor 51 rotates, the drive gear 11 rotates integrally with the drive shaft 52a. The drive gear 11 meshes with the follower gear 12 and transmits rotational force transmitted from the shaft 51a of the motor 51 through the coupling 52 to the follower gear 12.

As illustrated in FIG. 2, the follower gear 12 meshing with the drive gear 11 is attached to the axle 53. More specifically, the follower gear 12 is tightly fitted to the axle 53. The follower gear 12 rotates integrally with the axle 53 as the drive gear 11 rotates. In the embodiment, the follower gear 12 has a larger diameter and more teeth than the drive gear 11.

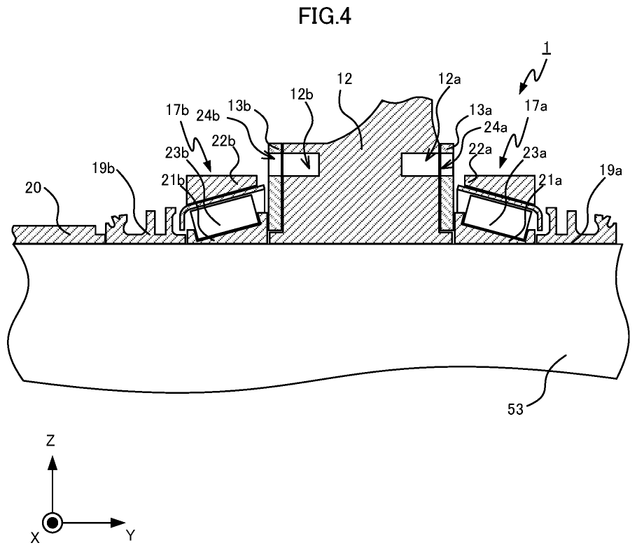

As illustrated in FIG. 4 that is a partially enlarged view of FIG. 3, the follower gear 12 has screw holes 12a for attaching the ring 13a in the surface facing in the positive Y-direction. The fasteners 14a and 14b are not illustrated in FIG. 4. The screw holes 12a are threaded to allow the fasteners 14a in FIG. 3 to be screwed in. In the embodiment, four screw holes 12a are arranged at regular intervals in the circumferential direction about Y-axis. As illustrated in FIG. 2, the ring 13a is attached to the follower gear 12 at four points.

The follower gear 12 has screw holes 12b for attaching the ring 13b in the surface facing in the negative Y-direction. The screw holes 12b are threaded to allow the fasteners 14b to be screwed in. In the embodiment, similarly to the screw holes 12a, four screw holes 12b are arranged at regular intervals in the circumferential direction about Y-axis. The ring 13b is attached to the follower gear 12 at four points.

The ring 13a is attached to the follower gear 12 and faces the follower-shaft bearing 17a. In the embodiment, the ring 13a has an outer diameter larger than the inner diameter of the outer race 22a in the follower-shaft bearing 17a at the surface of the outer race 22a facing the ring 13a. The ring 13a has an outer diameter that is preferably larger than the outer diameter of the outer race 22a in the follower-shaft bearing 17a at the surface of the outer race 22a facing the ring 13a. The ring 13a has an inner diameter smaller than the outer diameter of the inner race 21a in the follower-shaft bearing 17a at the surface of the inner race 21a facing the ring 13a. The ring 13a has an inner circumferential surface that is preferably spaced from the outer circumferential surface of the axle 53.

As illustrated in FIG. 4, the ring 13a has through-holes 24a for receiving the fasteners 14a. More specifically, the through-holes 24a are located to correspond to the screw holes 12a. When the fasteners 14a placed through the through-holes 24a are screwed into the screw holes 12a, the ring 13a is attached to the follower gear 12.

The ring 13b is attached to the follower gear 12 and faces the follower-shaft bearing 17b. In the embodiment, the ring 13b has an outer diameter larger than the inner diameter of the outer race 22b in the follower-shaft bearing 17b at the surface of the outer race 22b facing the ring 13b. The ring 13b has an outer diameter that is preferably larger than the outer diameter of the outer race 22b in the follower-shaft bearing 17b at the surface of the outer race 22b facing the ring 13b. The ring 13b has an inner diameter smaller than the outer diameter of the inner race 21b in the follower-shaft bearing 17b at the surface of the inner race 21b facing the ring 13b. The ring 13b has an inner circumferential surface that is preferably spaced from the outer circumferential surface of the axle 53.

The ring 13b has through-holes 24b for receiving the fasteners 14b. More specifically, the through-holes 24b are located to face the screw holes 12b. When the fasteners 14b extending through the through-holes 24b are attached to the follower gear 12, the ring 13b is attached to the follower gear 12.

The rings 13a and 13b are attached to the follower gear 12 and rotate integrally with the follower gear 12. Thus, the rings 13a and 13b are formed from a material having rigidity to the extent that the rings 13a and 13b are not broken by the rotation. For example, the rings 13a and 13b are annular members formed from a steel material, such as chrome molybdenum steel, with a thickness of 10 mm.

The fasteners 14a illustrated in FIG. 3 are threaded to be screwable into the screw holes 12a in the follower gear 12 through the through-holes 24a in the ring 13a.

The fasteners 14b are threaded to be screwable into the screw holes 12b in the follower gear 12 through the through-holes 24b in the ring 13b.

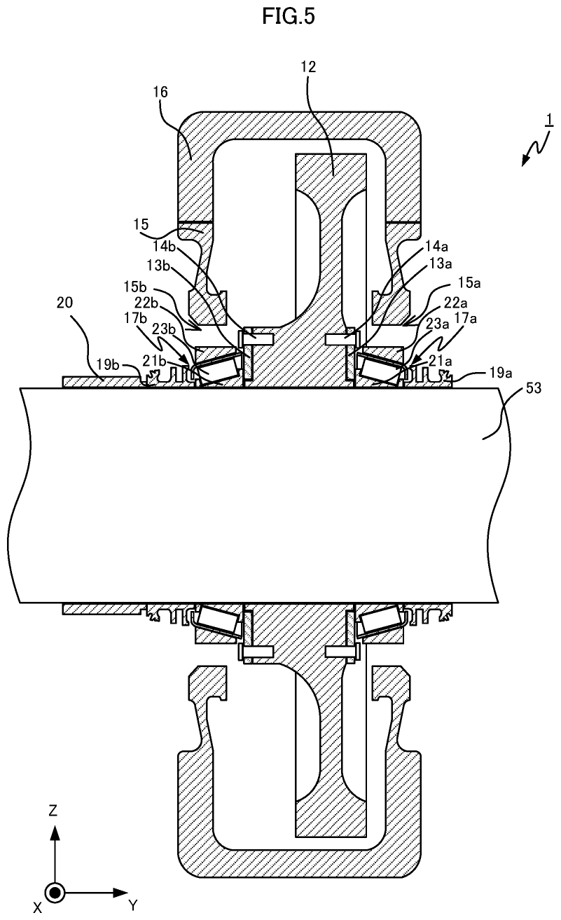

The gear box 15 illustrated in FIGS. 2 and 3 accommodates the drive gear 11, the follower gear 12, the rings 13a and 13b attached to the follower gear 12, the follower-shaft bearings 17a and 17b, and a pair of drive-shaft bearings, which is not illustrated, that supports the drive shaft 52a in a rotatable manner. As illustrated in FIG. 5 that corresponds to FIG. 3 without illustrating the bearing holders 18a and 18b, the gear box 15 has openings 15a and 15b in two surfaces intersecting with Y-axis. More specifically, the gear box 15 has the openings 15a and 15b in portions facing the rings 13a and 13b. To place the axle 53 through the follower gear 12 accommodated in the gear box 15, the openings 15a and 15b are shaped and sized to receive the axle 53. The opening 15a is shaped and sized to receive the follower-shaft bearing 17a and the ring 13a. The opening 15b is shaped and sized to receive the follower-shaft bearing 17b and the ring 13b.

As illustrated in FIG. 3, the opening 15a is closed with the bearing holder 18a and the oil thrower 19a, and the opening 15b is closed with the bearing holder 18b and the oil thrower 19b. The opening in the gear box 15 at the top in the vertical direction is closed with the lid 16. The gear box 15 has no opening at the bottom in the vertical direction. The drive gear 11 and the follower gear 12 are placed in and out of the gear box 15 through the opening at the top in the vertical direction.

The follower-shaft bearings 17a and 17b support the axle 53 in a rotatable manner. More specifically, the inner race 21a in the follower-shaft bearing 17a is attached to the axle 53 and rotates integrally with the axle 53. More specifically, the inner race 21a is fixed to the axle 53 immovably in Y-direction during the rotation of the axle 53. For example, the inner race 21a is press-fitted to the axle 53. The outer race 22a is held on the bearing holder 18a. More specifically, the outer race 22a is fixed to the bearing holder 18a. For example, the outer race 22a is press-fitted to the bearing holder 18a. The rolling elements 23a are located between the inner race 21a and the outer race 22a to roll as the inner race 21a rotates integrally with the axle 53. When the bearing holder 18a is removed from the gear box 15, the follower-shaft bearing 17a is slidable in Y-direction. More specifically, when pushed in the positive Y-direction by the ring 13a, the follower-shaft bearing 17a moves in the positive Y-direction, and is thus removable from the axle 53 without being broken.

The inner race 21b in the follower-shaft bearing 17b is attached to the axle 53 and rotates integrally with the axle 53. More specifically, the inner race 21b is firmly fixed to the axle 53 immovably in Y-direction during the rotation of the axle 53. For example, the inner race 21b is press-fitted to the axle 53. The outer race 22b is held on the bearing holder 18b. More specifically, the outer race 22b is fixed to the bearing holder 18b. For example, the outer race 22b is press-fitted to the bearing holder 18b. The rolling elements 23b are located between the inner race 21b and the outer race 22b to roll as the inner race 21b rotates integrally with the axle 53. When the bearing holder 18b is removed from the gear box 15, the follower-shaft bearing 17b is slidable in Y-direction. More specifically, when pressed by the ring 13b in the negative Y-direction, the follower-shaft bearing 17b moves in the negative Y-direction, and is removable from the axle 53 without being broken.

The bearing holder 18a illustrated in FIG. 3 is attached to the surface of the gear box 15 facing in the positive Y-direction. The bearing holder 18 holds the follower-shaft bearing 17a and closes the opening 15a in the gear box 15 illustrated in FIG. 5. The bearing holder 18b illustrated in FIG. 3 is attached to the surface of the gear box 15 facing in the negative Y-direction. The bearing holder 18b holds the follower-shaft bearing 17b and closes the opening 15b in the gear box 15 illustrated in FIG. 5.

The oil throwers 19a and 19b are attached to the axle 53 at positions to hold the follower-shaft bearings 17a and 17b in between. More specifically, the oil throwers 19a and 19b are fixed to the axle 53. For example, the oil throwers 19a and 19b are press-fitted to the axle 53. The oil throwers 19a and 19b have recesses and protrusions on the outer circumferential surfaces. The recesses and protrusions on the outer circumferential surface of the oil thrower 19a define a labyrinth flow path between the oil thrower 19a and the bearing holder 18a. The recesses and protrusions on the outer circumferential surface of the oil thrower 19b define a labyrinth flow path between the oil thrower 19b and the bearing holder 18b. These labyrinth flow paths prevent leakage of a lubricant, which is not illustrated, contained in the gear box 15 from the gear box 15.

The earth ring 20 is formed from a conductive material, and passes a current from the body of the railway vehicle through a ground brush, which is not illustrated, to the rails. The earth ring 20 is firmly fixed to the axle 53 immovably in Y-direction during the rotation of the axle 53. For example, the earth ring 20 is press-fitted to the axle 53.

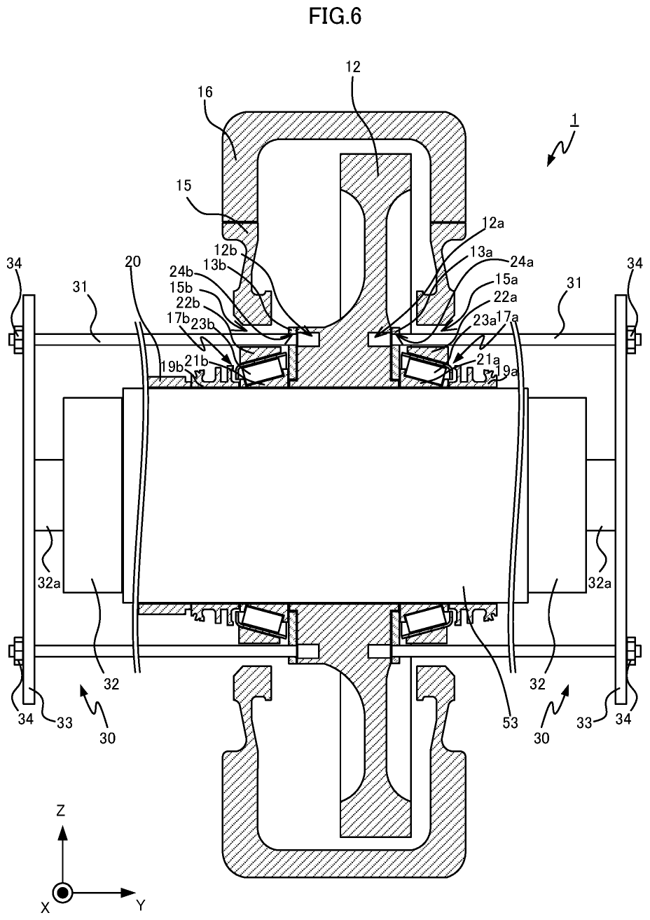

A method for removing the follower-shaft bearings 17a and 17b from the gear device 1 with the above structure is described below. The gear devices 1 are removed from the truck 50 illustrated in FIG. 1, the wheels 54 are removed from the axles 53, and, as illustrated in FIG. 5, the bearing holders 18a and 18b are removed from the gear device 1 illustrated in FIG. 3. Thereafter, the follower-shaft bearings 17a and 17b are removed using bearing removers 30 illustrated in FIG. 6.

More specifically, each bearing remover 30 includes removal tools 31 attachable to the ring 13a or 13b, a driver 32 that urges the ring 13a or 13b away from the follower gear 12 by extending a rod 32a, a plate 33 in contact with the rod 32a, and fasteners 34 that fix the removal tools 31 to the plate 33.

In the embodiment, each bearing remover 30 includes four rod-like removal tools 31. Each removal tool 31 has two threaded ends. The through-holes 24a in the ring 13a and the through-holes 24b in the ring 13b are threaded portions, or more specifically, threaded holes into which one threaded end of the removal tool 31 is screwable. In other words, the through-holes 24a in the ring 13a and the through-holes 24b in the ring 13b are examples of device receivers to which the bearing remover 30 is attachable.

The other end of each removal tool 31 extends through the corresponding plate 33 and is fixed to the plate 33 by being fastened with the corresponding fastener 34. Each removal tool 31 is formed from a material, such as iron or a steel material, that has rigidity to the extent that each removal tool 31 is not deformed with a force applied when the rings 13a and 13b are removed.

The driver 32 is a hydraulic cylinder having, for example, one end in contact with the axle 53 and the other end receiving the rod 32a. The driver 32 extends the rod 32a away from the axle 53.

The plate 33 is placed in contact with the rod 32a when the rod 32a is at an initial position, or the rod 32a is not extended. For example, the plate 33 is attached to the rod 32a when the rod 32a at the initial position is fitted to a fit-in hole in the plate 33. As described above, with the plate 33 attached to the rod 32a, the removal tools 31 are fixed to the plate 33. The plate 33 is formed from a material, such as iron or a steel material, that has rigidity to the extent that the plate 33 is not deformed when being pressed by the rod 32a.

A method for removing the follower-shaft bearing 17a from the gear device 1 is described below. As illustrated in FIG. 6, the four removal tools 31 in the bearing remover 30 located in the positive Y-direction from the gear device 1 each have one end inserted and screwed into the corresponding through-hole 24a in the ring 13a. Thus, the four removal tools 31 are attached to the ring 13a. The removal tools 31 are not inserted into the screw holes 12a in the follower gear 12. To prevent the removal tools 31 from being inserted into the screw holes 12a, the through-holes 24a in the ring 13a are preferably larger than the screw holes 12a in the follower gear 12. In this case, the fasteners 14a may be shaped to have radially stepwise sizes.

The other end of each of the four removal tools 31 extends through the plate 33 and is fastened with the corresponding fastener 34. Thus, the four removal tools 31 are attached to the plate 33.

The driver 32 extends the rod 32a away from the axle 53, or in the positive Y-direction. Thus, the plate 33 moves in the positive Y-direction, and the four removal tools 31 move in the positive Y-direction with the plate 33 moving. Thus, the ring 13a to which the four removal tools 31 are attached is urged away from the follower gear 12, or in the positive Y-direction, and moves in the positive Y-direction. In other words, the driver 32 operates as a driver that urges the ring 13a away from the follower gear 12.

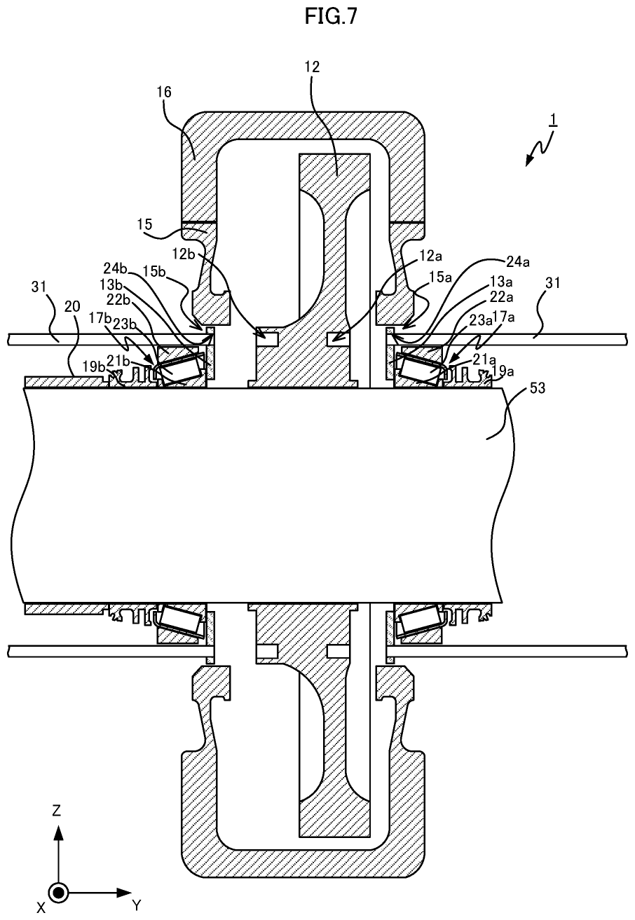

As described above, the ring 13a has an outer diameter larger than the inner diameter of the outer race 22a in the follower-shaft bearing 17a at the surface of the outer race 22a facing the ring 13a, and the ring 13a has an inner diameter smaller than the outer diameter of the inner race 21a in the follower-shaft bearing 17a at the surface of the inner race 21a facing the ring 13a. Thus, when the ring 13a moves in the positive Y-direction, the ring 13a comes in contact with the follower-shaft bearing 17a. When the ring 13a is further urged by the driver 32 away from the follower gear 12, as illustrated in FIG. 7, the ring 13a in contact with the follower-shaft bearing 17a moves in the positive Y-direction along the axle 53. As described above, when the ring 13a moves in the positive Y-direction, the follower-shaft bearing 17a and the oil thrower 19a move in the positive Y-direction. When the plate 33 is removed after the oil thrower 19a arrives at the end of the axle 53, the follower-shaft bearing 17a and the oil thrower 19a can be removed from the axle 53.

The follower-shaft bearing 17b is removed in the same manner as well. More specifically, as illustrated in FIG. 6, the four removal tools 31 in the bearing remover 30 located in the negative Y-direction from the gear device 1 each have one end inserted and screwed into the corresponding through-hole 24b in the ring 13b. Thus, the four removal tools 31 are attached to the ring 13b. The removal tools 31 are not inserted into the screw holes 12b in the follower gear 12. To prevent the removal tools 31 from being inserted into the screw holes 12b, the through-holes 24b in the ring 13b are preferably larger than the screw holes 12b in the follower gear 12. In this case, the fasteners 14b may be shaped to have radially stepwise sizes.

The other end of each of the four removal tools 31 extends through the plate 33 and is fastened with the corresponding fastener 34. Thus, the four removal tools 31 are attached to the plate 33.

The driver 32 extends the rod 32a away from the axle 53, or in the negative Y-direction. Thus, the plate 33 moves in the negative Y-direction, and the four removal tools 31 move in the negative Y-direction with the plate 33 moving. Thus, the ring 13b to which the four removal tools 31 are attached is urged away from the follower gear 12, or in the negative Y-direction, and moves in the negative Y-direction. In other words, the driver 32 operates as a driver that urges the ring 13b away from the follower gear 12.

As described above, the ring 13b has an outer diameter larger than the inner diameter of the outer race 22b in the follower-shaft bearing 17b at the surface of the outer race 22b facing the ring 13b, and the ring 13b has an inner diameter smaller than the outer diameter of the inner race 21b in the follower-shaft bearing 17b at the surface of the inner race 21b facing the ring 13b. Thus, when the ring 13b moves in the negative Y-direction, the ring 13b comes in contact with the follower-shaft bearing 17b. When the ring 13b is further urged by the driver 32 away from the follower gear 12, as illustrated in FIG. 7, the ring 13b in contact with the follower-shaft bearing 17b moves in the negative Y-direction along the axle 53. As described above, when the ring 13b moves in the negative Y-direction, the follower-shaft bearing 17b, the oil thrower 19b, and the earth ring 20 move in the negative Y-direction. When the plate 33 is removed after the earth ring 20 arrives at the end of the axle 53, the follower-shaft bearing 17b, the oil thrower 19b, and the earth ring 20 can be removed from the axle 53.

After the follower-shaft bearings 17a and 17b are removed, the rings 13a and 13b are attached to the follower gear 12 again, and new follower-shaft bearings 17a and 17b are attached to the axle 53. Thereafter, the oil throwers 19a and 19b, the earth ring 20, and the bearing holders 18a and 18b are attached. This completes the replacement of the follower-shaft bearings 17a and 17b.

As described above, in the gear device 1 including the rings 13a and 13b, the follower-shaft bearings 17a and 17b can be removed easily from the axle 53 using the bearing remover 30. As described above, the rings 13a and 13b in contact with the follower-shaft bearings 17a and 17b move along the axle 53, and thus the follower-shaft bearings 17a and 17b are removed from the axle 53. To remove the follower-shaft bearings 17a and 17b in the above manner, the follower gear 12 remains unremoved from the axle 53. Thus, the follower-shaft bearings 17a and 17b can be removed easily from the gear device 1.

The present disclosure is not limited to the above embodiment.

The rings 13a and 13b may be attached to the follower gear 12 in any manner, rather than being fastened with the fasteners 14a and 14b, when the rings 13a and 13b are firmly attached without being removed from the follower gear 12 during rotation. In one example, the rings 13a and 13b may be attached to the follower gear 12 by shrink fitting.

In examples other than the above example, the removal tools 31 may be attached to the rings 13a and 13b in any manner without being separated from the rings 13a and 13b with a force applied when the rings 13a and 13b are removed. In one example, the rings 13a and 13b may each have a threaded protrusion, and the removal tools 31 may each have a threaded screw hole at one end. The protrusion on the ring 13a or 13b may be screwed into the screw hole at one end of the corresponding removal tool 31 to attach the removal tool 31 to the ring 13a or 13b.

In another example, the rings 13a and 13b may have fit portions to which the bearing remover 30 can be fit, to serve as device receivers to which the bearing remover 30 is attachable. More specifically, the through-holes 24a in the ring 13a and the through-holes 24b in the ring 13b may be fit-in holes into which the removal tools 31 can be fitted. For example, an elastic member that deforms when pressed may be attached to one end of the removal tool 31. One of the removal tools 31 to which the elastic member is attached may be inserted into and fitted to the through-hole 24a or 24b.

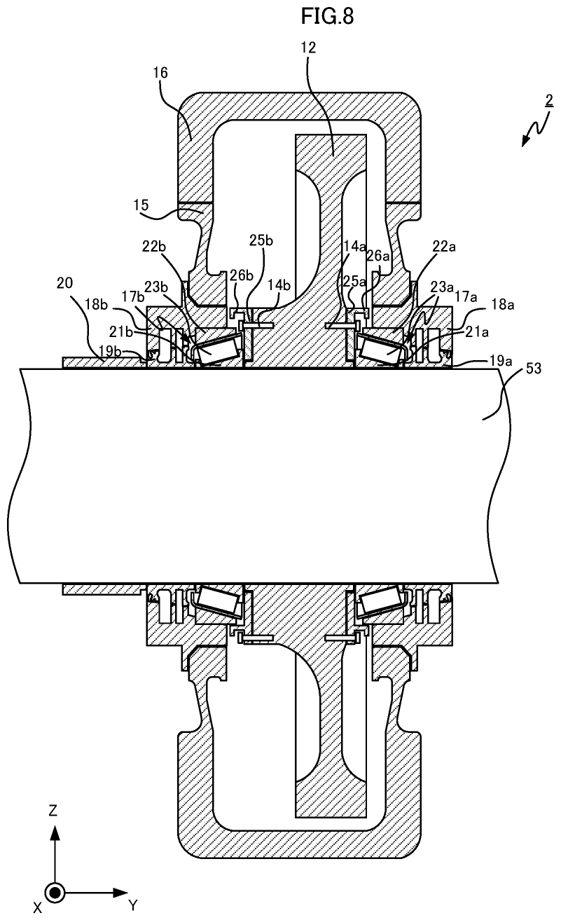

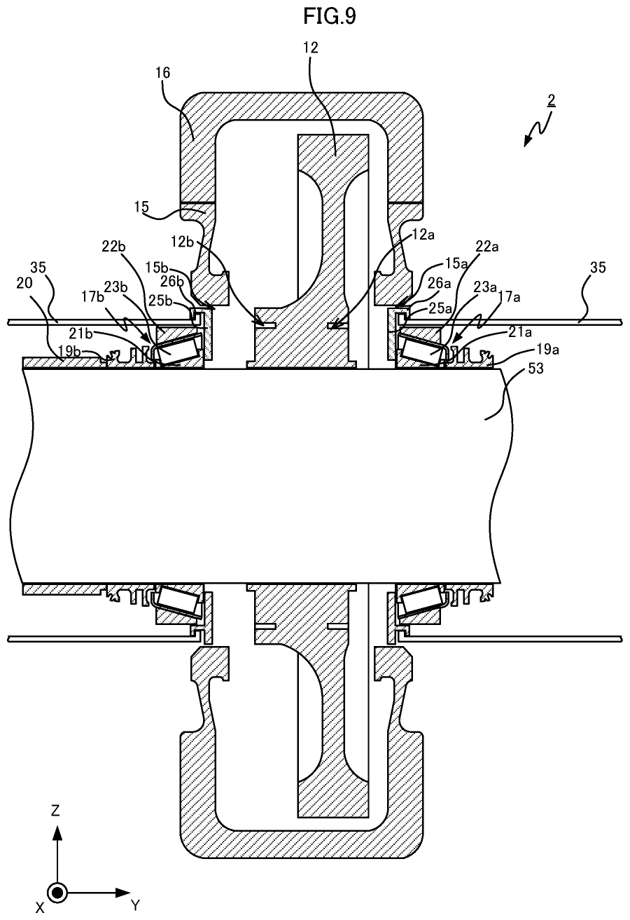

In another example, a gear device 2 illustrated in FIG. 8 includes hook-like locks 26a and 26b serving as device receivers to which the bearing remover 30 is attachable. The locks 26a and 26b have distal ends preferably protruding in the same direction. As illustrated in FIG. 9, the bearing remover 30 may include removal tools 35 each having one end bent to be hooked on the corresponding lock 26a or 26b.

The rings 13a, 13b, 25a, and 25b may not be annular but may have any other shapes. For example, the rings 13a, 13b, 25a, and 25b may have a partially-open annular shape, or a shape including multiple arcs spaced from one another. In another example, the rings 13a, 13b, 25a, and 25b may have a polygonal shape with a through-hole at the center, or a shape including multiple rectangles spaced from one another. In another example, the rings 13a, 13b, 25a, and 25b may not be a plate but may be a block.

The rings 13a, 13b, 25a, and 25b may be attached to the drive gear 11. For example, when the rings 13a and 13b are attached to the drive gear 11, a pair of drive-shaft bearings, which is not illustrated, that supports the drive shaft in a rotatable manner can be removed easily. The rings 13a and 13b may be attached to the drive gear 11 and the follower gear 12.

The follower-shaft bearings 17a and 17b may be sliding bearings, in place of the rolling bearings described in the above embodiment.

The oil throwers 19a and 19b may be attached to the axle 53 in a manner other than in the above example. The oil throwers 19a and 19b may be firmly attached to the axle 53 immovably in Y-direction during the rotation of the axle 53. For example, the oil throwers 19a and 19b may move in the circumferential direction without moving in Y-direction during the rotation of the axle 53. In other words, the oil throwers 19a and 19b may rotate relative to the axle 53.

The removal tools 31 may be other than rods. For example, the removal tools 31 may be wires including threaded metal members attached at two ends. In another example, the removal tools 31 may be cylindrical members. In this case, one end of the cylindrical member may be fitted to the ring 13a or 13b.

The gear device may have any number of removal tools 31 or 35, rather than the number in the above example.

The removal tools 31 or 35 may be fixed to the plate 33 in any manner other than the manner described in the above example. In one example, the removal tools 31 or 35 may be attached to the plate 33 by a method such as welding, bonding with an adhesive, or fitting.

The driver 32 may be any device, in place of a hydraulic cylinder, that can urge the rings 13a, 13b, 25a, and 25b away from the follower gear 12.

The bearing remover 30 may have any structure that can urge the rings 13a, 13b, 25a, and 25b away from the follower gear 12.

The gear device 1 or 2 may be installed in any movable body such as an automobile or a bus, or an industrial machine, in place of a railway vehicle.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1, 2 Gear device
11 Drive gear
12 Follower gear
12a, 12b Screw hole
13a, 13b, 25a, 25b Ring
14a, 14b, 34 Fastener
15 Gear box
15a, 15b Opening
16 Lid
17a, 17b Follower-shaft bearing
18a, 18b Bearing holder
19a, 19b Oil thrower
20 Earth ring
21a, 21b Inner race
22a, 22b Outer race
23a, 23b Rolling element
24a, 24b Through-hole
26a,26b Lock
30 Bearing remover
31,35 Removal tool
32 Driver
32a Rod
33 Plate
50 Truck
51 Motor
51a Shaft
52 Coupling
52a Drive shaft
53 Axle
54 Wheel

1. A gear device, comprising:
a gear attached to a shaft to rotate integrally with the shaft;
a pair of bearings located across the gear in a direction in which the shaft extends, the pair of bearings supporting the shaft in a rotatable manner; and
a plurality of removable members attached to two surfaces of the gear intersecting with the shaft, each removable member of the plurality of removable members facing a bearing of the pair of bearings located across the gear.

2. The gear device according to claim 1, wherein
the plurality of removable members are attached to the two surfaces of the gear intersecting with the shaft, and include two rings, at least a portion of each ring of the two rings facing the pair of bearings.

3. The gear device according to claim 2, wherein
each bearing of the pair of bearings includes an inner race, an outer race, and a plurality of rolling elements held between the inner race and the outer race,
each of the two rings has an outer diameter larger than an inner diameter of the outer race in each bearing of the pair of bearings at a surface of the outer race facing the ring, and
each of the two rings has an inner diameter smaller than an outer diameter of the inner race in each bearing of the pair of bearings at a surface of the inner race facing the ring.

4. The gear device according to claim 1, wherein
each removable member of the plurality of removable members includes a device receiver to which a bearing remover is attachable, and
the plurality of removable members are urged away from the gear by the bearing remover attached to the device receiver to move away from the gear while at least a portion of each removable member of the plurality of removable members is in contact with the bearing facing the at least one removable member.

5-10 (canceled)

11. The gear device according to claim 2, wherein
each removable member of the plurality of removable members includes a device receiver to which a bearing remover is attachable, and
the plurality of removable members are urged away from the gear by the bearing remover attached to the device receiver to move away from the gear while at least a portion of each removable member of the plurality of removable members is in contact with the bearing facing the at least one removable member.

12. The gear device according to claim 3, wherein
each removable member of the plurality of removable members includes a device receiver to which a bearing remover is attachable, and
the plurality of removable members are urged away from the gear by the bearing remover attached to the device receiver to move away from the gear while at least a portion of each removable member of the plurality of removable members is in contact with the bearing facing the at least one removable member.

13. The gear device according to claim 4, wherein
the device receiver includes a screw portion into which the bearing remover is screwable.

14. The gear device according to claim 11, wherein
the device receiver includes a screw portion into which the bearing remover is screwable.

15. The gear device according to claim 12, wherein
the device receiver includes a screw portion into which the bearing remover is screwable.

16. The gear device according to claim 4, wherein
the device receiver includes a fit portion to which the bearing remover is fittable.

17. The gear device according to claim 11, wherein
the device receiver includes a fit portion to which the bearing remover is fittable.

18. The gear device according to claim 12, wherein
the device receiver includes a fit portion to which the bearing remover is fittable.

19. The gear device according to claim 4, wherein
the device receiver includes a lock on which the bearing remover is to be locked.

20. The gear device according to claim 11, wherein
the device receiver includes a lock on which the bearing remover is to be locked.

21. The gear device according to claim 12, wherein
the device receiver includes a lock on which the bearing remover is to be locked.

22. The gear device according to claim 4, further comprising:
a gear box having an opening that is openable and closable, the gear box accommodating the gear, the pair of bearings, and the plurality of removable members, wherein
the bearing remover is attachable to the device receiver in each removable member of the plurality of removable members through the opening.

23. A bearing remover, comprising:
a removal tool attachable to the device receiver in each removable member of the plurality of removable members included in the gear device according to claim 4; and
a driver to urge the removal tool away from the gear.

24. A bearing removal method for removing a pair of bearings from a gear device, the gear device including a gear attached to a shaft to rotate integrally with the shaft, the pair of bearings located across the gear in a direction in which the shaft extends and supporting the shaft in a rotatable manner, and a plurality of removable members attached to two surfaces of the gear intersecting with the shaft, each removable member of the plurality of removable members facing a bearing of the pair of bearings, the method comprising:
urging the plurality of removable members away from the gear to move the plurality of removable members away from the gear while each removable member of the plurality of removable members is in contact with a bearing of the pair of bearings facing the removable member of the plurality of removable members.
